(19) United States
(12) Patent Application Publication
(10) Pub. No.: US 2025/0036559 A1
(43) Pub. Date: Jan. 30, 2025

(54) PROACTIVE DETECTION OF API PERFORMANCE AND RELIABILITY IN CI/CD PIPELINES

(71) Applicant: Cisco Technology, Inc., San Jose, CA (US)

(72) Inventors: Thomas Szigeti, Vancouver (CA); David John Zacks, Vancouver (CA); Barry Qi Yuan, Vancouver (CA); Robert E. Barton, Richmond (CA)

(21) Appl. No.: 18/225,861

(22) Filed: Jul. 25, 2023

(51) Int. Cl. G06F 11/36; G06F 9/54

(52) U.S. Cl. CPC G06F 11/3664; G06F 9/547

(57) ABSTRACT

In one embodiment, a device identifies an application programming interface call within new code for an application. The device conducts testing of a plurality of endpoints associated with the application programming interface call. The device selects, based on results of the testing, a particular endpoint from among the plurality of endpoints. The device steers the application programming interface call made by the application towards the particular endpoint.

### TECHNICAL FIELD

The present disclosure relates generally to computer networks, and, more particularly, to proactive detection of application programming interface (API) performance and reliability in continuous integration and continuous delivery (CI/CD) pipelines.

### BACKGROUND

Modern cloud native applications extensively leverage services via application programming interfaces (APIs). For example, a given application may use Twilio for cloud communication, Stripe for payment processing, Google Maps for geolocation for delivery, and the like. Thus, a key goal of an application developer today is to bring all of the services used by the application together into a seamless experience for a user that is highly available, highly reliable, and highly responsive.

When developers include API requests within their code, they leave it to Domain Name System (DNS) resolution to resolve these calls to a given API endpoint host. However, some API endpoint hosts are nearer than others, more efficient than others, more reliable than others, etc. Today, though, application developers have no insight into any of these metrics, nor have the time to do such testing of these endpoints. Moreover, even if such a mechanism were to exist, the developers would still have no way to explicitly direct their API calls to the most reliable and highest performing API endpoint host instances.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an architecture for the proactive detection of application programming interface (API) performance and reliability in continuous integration and continuous delivery (CI/CD) pipelines;

FIG. 5 illustrates an example of using a sidecar to perform API performance testing;

FIG. 6 illustrates an example of application response time (ART) monitoring;

FIG. 7 illustrates an example of steering API calls; and

FIG. 8 illustrates an example simplified procedure for optimizing API calls by an online application.

### DESCRIPTION OF EXAMPLE EMBODIMENTS

### Overview

According to one or more embodiments of the disclosure, a device identifies an application programming interface call within new code for an application. The device conducts testing of a plurality of endpoints associated with the application programming interface call. The device selects, based on results of the testing, a particular endpoint from among the plurality of endpoints. The device steers the application programming interface call made by the application towards the particular endpoint.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

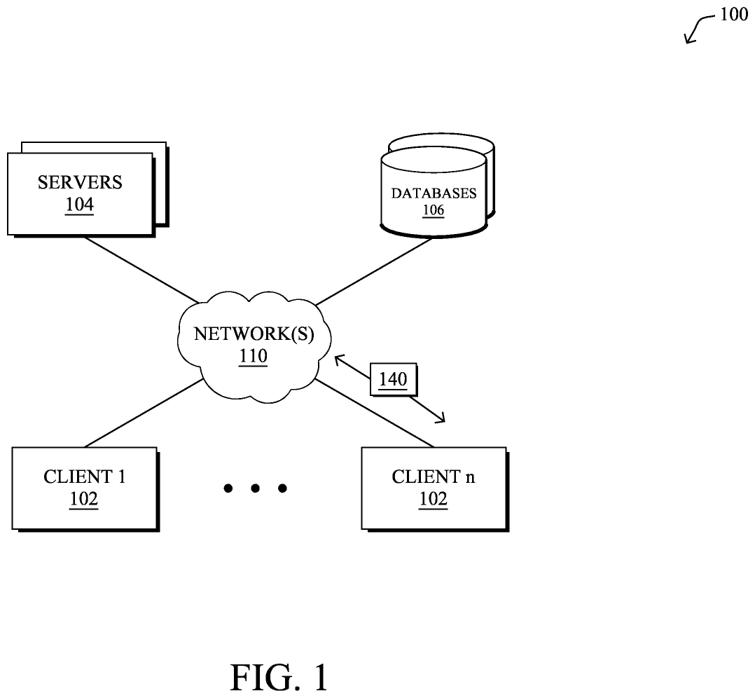

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

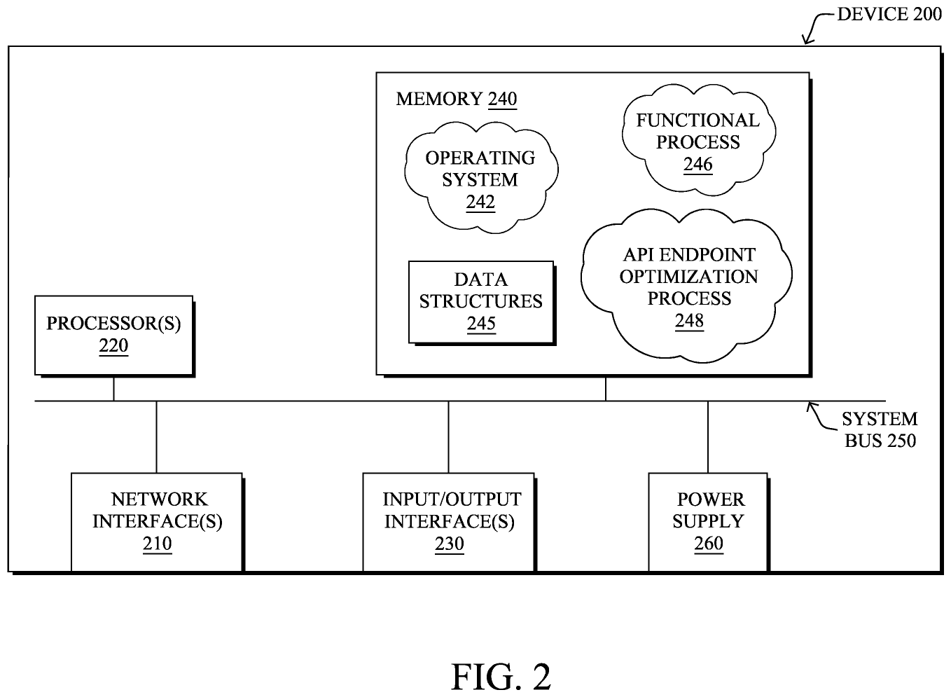

FIG. 2 is a schematic block diagram of an example node/device 200 (e.g., an apparatus) that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative API endpoint optimization process 248, as described herein. Notably, functional processes 246, when executed by processor(s) 220, cause each particular device 200 to perform the various functions corresponding to the particular device's purpose and general configuration.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

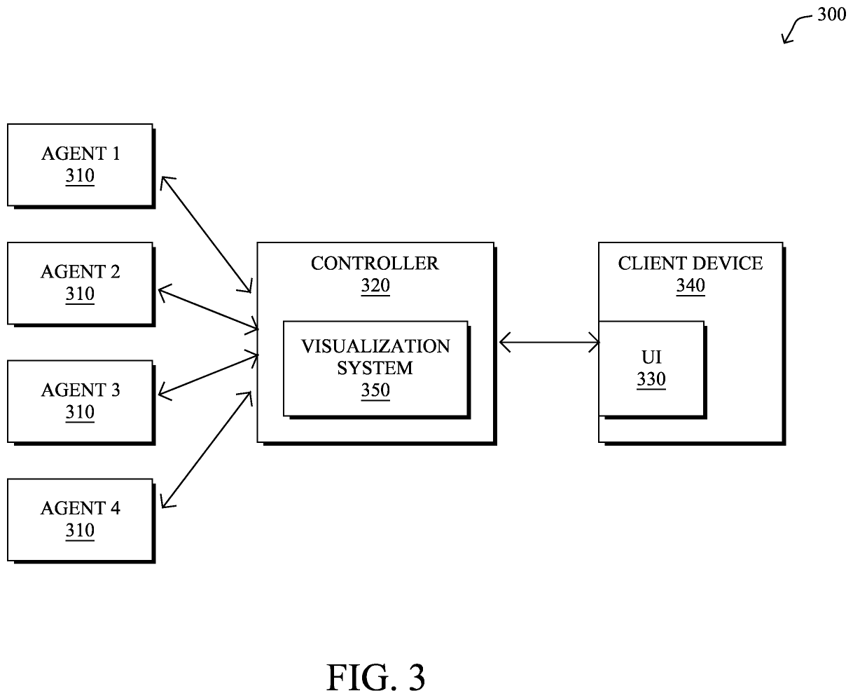

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, an instance of controller 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a Hypertext Transfer Protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

As noted above, observability intelligence platform 300 is able to assess the performance of an online application during use of the application. However, such application monitoring today has no awareness as to which API endpoints are available to the application. In addition, any mitigation actions for poor application performance detected by observability intelligence platform 300 are reactionary in nature, meaning that the poor performance often affects users of the application. Indeed, application developers typically have no insight into how their API calls may affect performance, nor have any visibility into how these calls perform, prior to deployment.

### Proactive Detection of API Performance and Reliability in CI/CD Pipelines

According to various implementations, the techniques herein are able to proactively monitors API calls made by an online application before these are even instantiated (e.g., after changes are made to the code of the application but before its deployment). This allows the system to identify the most reliable and highest performing API endpoint hosts for a given call. Additionally, the techniques herein also provide for the automatic performance of synthetic testing of the API endpoints, which may also be complemented with direct observation and analysis of real flows, to further increase the degree of accuracy of the system. As a result, API calls are automatically and intelligently directed to the highest performing and most reliable endpoints, without any code changes required by the development team.

Illustratively, the techniques described herein may be performed by hardware, software, and/or firmware, such as in accordance with API endpoint optimization process 248, which may include computer executable instructions executed by the processor 220 (or independent processor of interfaces 210) to perform functions relating to the techniques described herein.

Specifically, according to various embodiments, a device identifies an application programming interface call within new code for an application. The device conducts testing of a plurality of endpoints associated with the application programming interface call. The device selects, based on results of the testing, a particular endpoint from among the plurality of endpoints. The device steers the application programming interface call made by the application towards the particular endpoint.

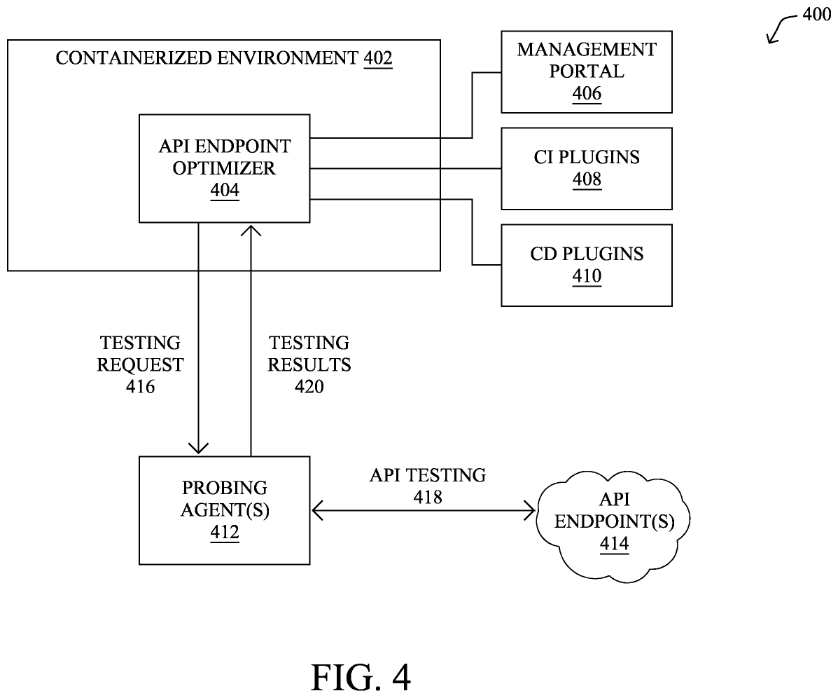

Operationally, FIG. 4 illustrates an architecture 400 for the proactive detection of API performance and reliability in CI/CD pipelines. As shown, assume that there is a containerized environment 402 that is used to provide an online application. For instance, containerized environment 402 may be based on Kubernetes or another suitable container orchestration system. As would be appreciated, many online applications are now deployed using containers, which represent an evolution over previous virtualization techniques, such as virtual machines (VMs), providing greater flexibility as this allow for the application to be easily deployed to any number of hardware platforms. Of course, the use of containerized environment 402 in architecture 400 is exemplary only and the techniques herein could also be employed in any number of other deployment scenarios, as well.

At the core of architecture 400 is API endpoint optimizer 404, which may be instantiated as a container within a given cluster of containerized environment 402 through the execution of API endpoint optimization process 248 by a specifically configured device (e.g., device 200) or set of devices, in which case the set of devices can be viewed herein as a singular device for purposes of executing API endpoint optimizer 404.

In some implementations, a management portal 406 may oversee the operations of API endpoint optimizer 404 and provide a user interface that allows an administrator to control and review the operations of API endpoint optimizer 404. Management portal 406 may also be implemented as a separate software-as-a-service (SaaS) application, embedded into a cloud native monitoring solution, integrated into an observability platform (e.g., platform 300), or the like.

In addition to API endpoint optimizer 404, containerized environment 402 may also interface with various CI plugins 408 and/or CD plugins 410, allowing it to perform its functions in conjunction with any number of CI/CD platforms. For instance, various CI plugins 408 may interface API endpoint optimizer 404 with platforms such as Docker, Jenkins, or the like. Similarly, CD plugins 410 may interface API endpoint optimizer 404 with platforms such as Helm, Terraform, and the like.

By integrating API endpoint optimizer 404 into the CI/CD pipeline via CI plugins 408 and/or CD plugins 410, API endpoint optimizer 404 may scan any application code checked into the registry, to identify any API calls included in the application code. In other cases, API endpoint optimizer 404 may receive an indication of any changes to the API calls by the application code from CI plugins 408 or CD plugins 410.

When API endpoint optimizer 404 identifies a new API call or change to an existing API call made by the code change, it may then identify one or more probing agents 412 and send a testing request 416 to those agent(s). For instance, probing agent(s) 412 may take the form of any number of path probing or other agents throughout a network that is used to access the online application and/or API endpoints 414. As would be appreciated, any given API may be accessible via any number of API endpoints 414 distributed throughout the world. For instance, agent(s) 412 may include a ThousandEyes probing agent or other similar probing agent that performs synthetic testing of the API endpoints 414 associated with a given API call in the application code.

In some instances, in response to testing request 416, an agent 412 may first determine whether it is already performing testing of a given API endpoint 414. If so, then a new series of testing is not only unnecessary, but redundant an inefficient. Accordingly, the agent 412 may take no further testing action and report its existing testing results 420 to API endpoint optimizer 404.

Conversely, if an agent 412 is not currently configured to test an API endpoint 414 indicated by testing request 416, it may then initiate API testing 418 and report the testing results 420 back to API endpoint optimizer 404. For instance, agent 412 may first perform a reachability test with an API endpoint 414. Provided this is met with a positive response, then it may proceed with ongoing performance and reliability testing for the API endpoint 414.

Generally, testing results 420 may include metrics relating to the latency (both network and server), as well as the reliability of the API endpoint 414. The probing agent 412 can also perform multiple Domain Name System (DNS) resolutions for the same API endpoint 414, to determine whether multiple endpoints hosts exist, and can similarly perform these performance and reliability tests on all known instances of the API endpoint, to report on the performance associated with each of the API endpoints 414 via testing results 420.

In some implementations, to compliment these basic, automated, and synthetic testing by probing agent(s) 412, Application Response Time (ART) functionality may also be encoded into a sidecar proxy of the application microservice, assuming a service mesh environment is used. Alternatively, the ART functionality could be implemented as a WebAssembly function or some other similar means, to tie it directly to the client service.

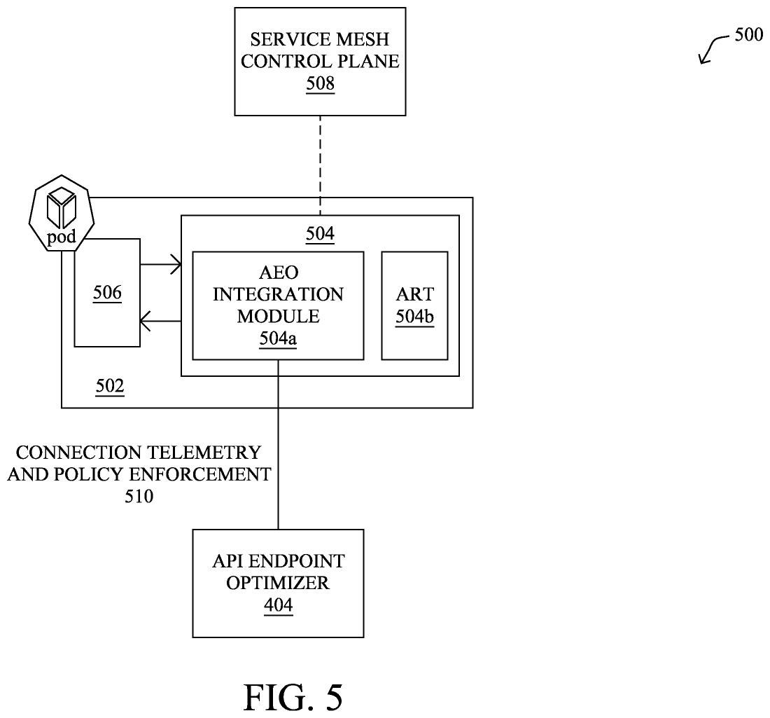

By way of example, consider architecture 500 in FIG. 5 in which a given microservice 506 of the online application is executed within a Kubenetes pod 502, which may comprise one or more containers. Overseeing the control plane traffic in the service mesh between such pods may be a service mesh control plane 508, such as Istio or the like.

As shown, associated with microservice 506 may also be a sidecar proxy 504 that is also executed within pod 502 and used to perform any number of functions with respect to microservice 506. For instance, sidecar proxy 504 may include lookup functions, firewall functions, security functions, or the like, as is typically done today. In addition, as shown, sidecar proxy 504 may also include ART functions 504b that interface with API endpoint optimizer 404 via an API endpoint optimizer (AEO) integration module 504a.

Through such integration, ART functions 504b may also monitor the real (i.e., non-synthetic) API traffic of the application and, more specifically, microservice 506 of the application, to provide more accurate and expanded metrics regarding the API calls. In turn, AEO integration module 504a may leverage ART functions 504b to capture and report the resulting connection telemetry and policy enforcement data 510 back to API endpoint optimizer 404. Such data 510 may include, for instance, metrics such as the Client Network Delay (CND), the Server Network Delay (SND), API endpoint delay (which would be the “Application Delay” as it is sometimes referred to) and even more accurate metrics for loss (as these would be based on the observed and comprehensive traffic flows, and not on periodic samples).

In some cases, the results from ART functions 504b may also be provided back to a cloud native management system, to optimize the API endpoint host selection, to maximize performance and reliability.

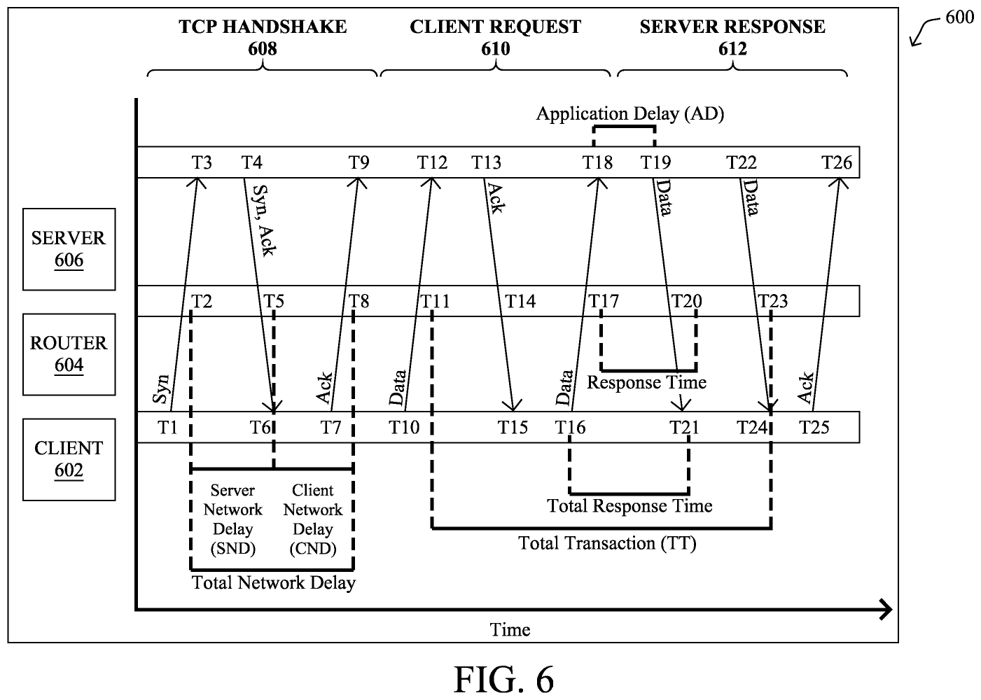

FIG. 6 illustrates an example 600 of application response time (ART) monitoring, in various embodiments. As shown, assume that there is a server 606, a router 604, and a client 602 that communicate with one another to perform a TCP handshake 608, a client request 610, and a server response 612. Metrics captured from such monitoring can include the SND and/or CND (which may form the total network delay), the application delay (AD), the response time, the total response time, the total transaction (TT) time, or the like.

While FIG. 6 demonstrates ART monitoring in the context of a hardware client, a network device, and a server, since what is being measured and analyzed is the behavior of the TCP traffic, ART functions 504b could perform similar measurements with respect to API requests, which are also performed over TCP. As such, the components illustrated above can applied to this context with the following contextual modifications:
The client corresponds to the requesting application microservice, such as microservice 506.
The network device corresponds to the sidecar proxy, such as sidecar proxy 504 (i.e., wherever the ART measurement is being taken).
The server corresponds to the API endpoint, such as any of API endpoint(s) 414.

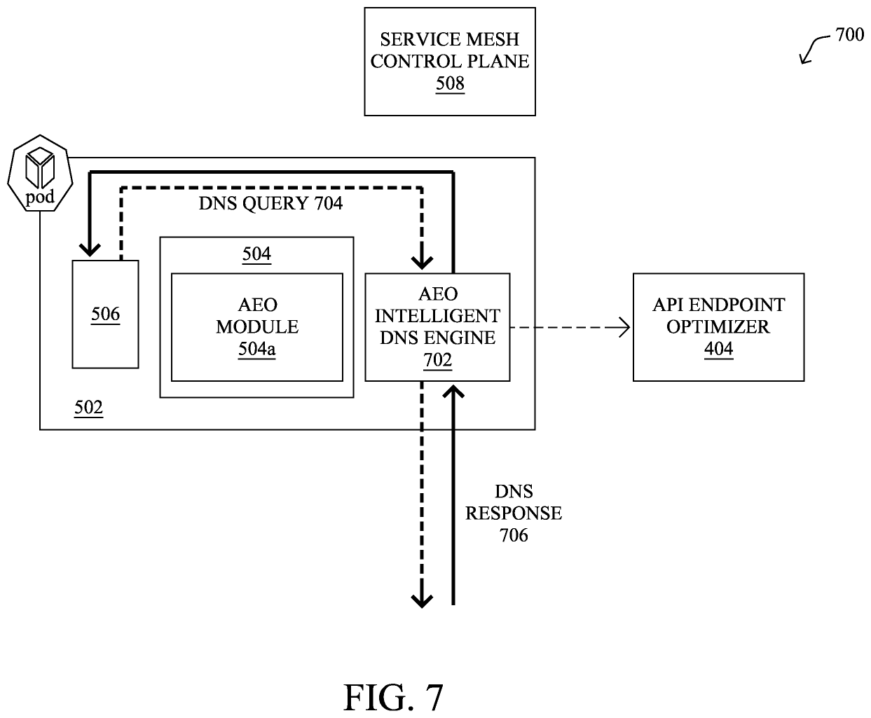

FIG. 7 illustrates an example 700 of steering API calls, according to various embodiments. Continuing the example shown previously in FIG. 5, assume again that there is a microservice 506 of an online application that is executed in the same pod 502 as that of a sidecar proxy 504. Within sidecar proxy 504 may be an AEO module 504a that interfaces sidecar proxy 504 with API endpoint optimizer 404. Regardless of whether API endpoint optimizer 404 obtains synthetic testing results from a probing agent 412 (e.g., based on the application code being checked in with a new or altered API call) or ART information is collected by a sidecar proxy, another key ability of the teachings herein is to steer the API calls to the best API endpoint.

In some instance, API endpoint optimizer 404 may store a listing indicative of the top performing API endpoint hosts. Then, whenever an application microservice instance is spun up and makes an API call, the system may intercept the DNS requests and reply from this cached list of endpoint hosts, so as to dynamically and transparently direct API calls to the endpoint hosts that have demonstrated the highest levels of reliability and performance.

More specifically, API endpoint optimizer 404 may interact with AEO intelligent DNS engine 702 to correlate the performance telemetry for the various API endpoints associated with a specific API call with DNS information for those endpoints. In turn, when microservice 506 issues a DNS query 704 in order to make an API call, AEO intelligent DNS engine 702 may intercept this request and perform a lookup of the best API endpoint to service this call, based on its associated performance telemetry. In turn, AEO intelligent DNS engine 702 may provide a DNS response 706 back to microservice 506, thereby directing microservice 506 to make its API calls to the endpoint hosts that have demonstrated the highest levels of reliability and performance. As would be appreciated, this is done without implementing any changes to the underlying application code.

In summary, the techniques herein allow for the automated identification of API calls within checked in code, thereby triggering proactive performance and reliability testing of API endpoints. In further aspects, the techniques herein automatically and intelligently direct API requests to the highest performing and most reliable API endpoints, as well.

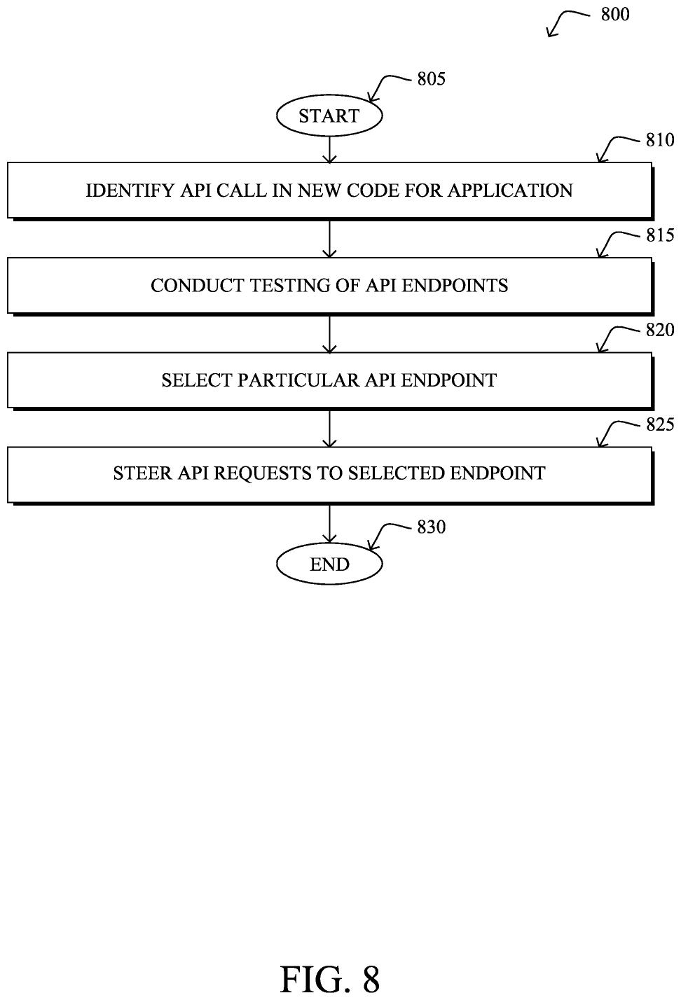

FIG. 8 illustrates an example simplified procedure 800 (e.g., a method) for optimizing API calls by an online application. For example, a non-generic, specifically configured device (e.g., device 200), may perform procedure 800 by executing stored instructions (e.g., API endpoint optimization process 248). The procedure 800 may start at step 805, and continues to step 810, where, as described in greater detail above, the device may identify an application programming interface call within new code for an application. In some instances, the device may do so in response to the new code being checked into a code repository (e.g., a repository of a CI and/or CD platform). In some implementations, the device identifies the application programming interface call based on an indication sent to the device via a plugin to a development platform.

At step 815, as detailed above, the device may conduct testing of a plurality of endpoints associated with the application programming interface call. In some instances, the device may do so by requesting that one or more probing agents send probe packets via a network towards the plurality of endpoints (e.g., ThousandEyes agents or the like). In further instances, testing of the plurality of endpoints is performed by a sidecar proxy associated with a microservice of the application. In one implementation, the sidecar proxy performs application response time testing based on the application making the application programming interface call.

At step 820, the device may select, based on results of the testing, a particular endpoint from among the plurality of endpoints, as described in greater detail above. In some instances, the results of the testing are indicative of response times associated with the plurality of endpoints. In further instances, the results of the testing are indicative of reliability metrics for the plurality of endpoints (e.g., how often an endpoint can be reached or responds, etc.).

At step 825, as detailed above, the device may steer the application programming interface call made by the application towards the particular endpoint. In various cases, the device may do so by intercepting a Domain Name System request from the application associated with the application programming interface call and returning a Domain Name System response to the application with an address of the particular endpoint. This can be done either directly (e.g., by the device itself performing the interception) or indirectly (e.g., the device instructs another mechanism to do so).

In some cases, the device may also select a different endpoint from among the plurality of endpoints, based on additional test results, thereby making the endpoint selection dynamic.

Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for proactive detection of API performance and reliability in CI/CD pipelines, it is to be understood that various other adaptations and modifications may be made within the intent and scope of the embodiments herein. In addition, while certain processes and protocols are shown, other suitable processes and protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method comprising:
identifying, by a device, an application programming interface call within new code for an application;
conducting, by the device, testing of a plurality of endpoints associated with the application programming interface call;
selecting, by the device and based on results of the testing, a particular endpoint from among the plurality of endpoints; and
steering, by the device, the application programming interface call made by the application towards the particular endpoint.

2. The method of claim 1, wherein the device identifies the application programming interface call in response to the new code being checked into a code repository.

3. The method of claim 1, wherein conducting testing of the plurality of endpoints comprises:
requesting that one or more probing agents send probe packets via a network towards the plurality of endpoints.

4. The method of claim 1, further comprising:
selecting, by the device, a different endpoint from among the plurality of endpoints, based on additional test results.

5. The method of claim 1, wherein steering the application programming interface call comprises:
intercepting a Domain Name System request from the application associated with the application programming interface call; and
returning a Domain Name System response to the application with an address of the particular endpoint.

6. The method of claim 1, the testing of the plurality of endpoints is performed by a sidecar proxy associated with a microservice of the application.

7. The method of claim 6, wherein the sidecar proxy performs application response time testing based on the application making the application programming interface call.

8. The method of claim 1, wherein the device identifies the application programming interface call based on an indication sent to the device via a plugin to a development platform.

9. The method of claim 1, wherein the results of the testing are indicative of response times associated with the plurality of endpoints.

10. The method of claim 1, wherein the results of the testing are indicative of reliability metrics for the plurality of endpoints.

11. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify an application programming interface call within new code for an application;
conduct testing of a plurality of endpoints associated with the application programming interface call;
select, based on results of the testing, a particular endpoint from among the plurality of endpoints; and
steer the application programming interface call made by the application towards the particular endpoint.

12. The apparatus of claim 11, wherein the apparatus identifies the application programming interface call in response to the new code being checked into a code repository.

13. The apparatus of claim 11, wherein the apparatus conducts testing of the plurality of endpoints by:
requesting that one or more probing agents send probe packets via a network towards the plurality of endpoints.

14. The apparatus of claim 11, wherein the process when executed is further configured to:
select a different endpoint from among the plurality of endpoints, based on additional test results.

15. The apparatus of claim 11, wherein the apparatus steers the application programming interface call by:
intercepting a Domain Name System request from the application associated with the application programming interface call; and
returning a Domain Name System response to the application with an address of the particular endpoint.

16. The apparatus of claim 11, the testing of the plurality of endpoints is performed by a sidecar proxy associated with a microservice of the application.

17. The apparatus of claim 16, wherein the sidecar proxy performs application response time testing based on the application making the application programming interface call.

18. The apparatus of claim 11, wherein the apparatus identifies the application programming interface call based on an indication sent to the apparatus via a plugin to a development platform.

19. The apparatus of claim 11, wherein the results of the testing are indicative of response times associated with the plurality of endpoints.

20. A tangible, non-transitory, computer-readable medium storing program instructions that cause a device to execute a process comprising:
identifying, by the device, an application programming interface call within new code for an application;
conducting, by the device, testing of a plurality of endpoints associated with the application programming interface call;
selecting, by the device and based on results of the testing, a particular endpoint from among the plurality of endpoints; and
steering, by the device, the application programming interface call made by the application towards the particular endpoint.
